(19) United States
(12) Patent Application Publication
(10) Pub. No.: US 2022/0261942 A1
(43) Pub. Date: Aug. 18, 2022

(54) METHOD, INFORMATION PROCESSING DEVICE, AND SYSTEM

(71) Applicant: TOYOTA JIDOSHA KABUSHIKI KAISHA, Toyota-shi (JP)

(72) Inventors: Ryo MURAKAMI, Susono-shi (JP); Yuji TACHIBANA, Nisshin-shi (JP); Minoru NAKADORI, Toyota-shi (JP); Daiki KANEICHI, Shinagawa-ku (JP)

(73) Assignee: TOYOTA JIDOSHA KABUSHIKI KAISHA, Toyota-shi (JP)

(21) Appl. No.: 17/665,899

(22) Filed: Feb. 7, 2022

(30) Foreign Application Priority Data
Feb. 18, 2021 (JP) 2021-024569

(51) Int. Cl. G06Q 50/30; G06Q 10/02; G08G 1/00; H04L 51/046

(52) U.S. Cl. CPC G06Q 50/30; H04L 51/046; G08G 1/202; G06Q 10/02

(57) ABSTRACT

A method is executed by an information processing device configured to communicate with a plurality of shared terminal devices respectively installed at places that are different from each other. The method includes a step of acquiring a vehicle dispatch request from a user via the shared terminal device, a step of determining a boarding position at which the user boards a first vehicle, and a step of determining a traveling plan of the first vehicle such that the first vehicle heads toward the boarding position.

### CROSS-REFERENCE TO RELATED APPLICATION

This application claims priority to Japanese Patent Application No. 2021-024569 filed on Feb. 18, 2021, incorporated herein by reference in its entirety.

### BACKGROUND

### 1. Technical Field

The present disclosure relates to a method, an information processing device, and a system.

### 2. Description of Related Art

There is a technology for providing a service using a shared terminal device, such as digital signage. For example, Japanese Unexamined Patent Application Publication No. 2015-225612 discloses a technology for displaying information for residents of a facility on a signage device installed in the facility and for providing the information to a mobile terminal of each of the residents.

SUMMARY

There is room for improvement in a technology for providing a service using a shared terminal device.

The present disclosure is to improve a technology' for providing a service using a shared terminal device.

A method according to a first aspect of the present disclosure is executed by an information processing device configured to communicate with a plurality of shared terminal devices respectively installed at places that are different from each other. The method includes acquiring a vehicle dispatch request from a user via each of the shared terminal devices, determining a boarding position at which the user boards a first vehicle, and determining a traveling plan of the first vehicle such that the first vehicle heads toward the boarding position.

In the first aspect, the method may further include notifying, when the user starts store leaving procedures using the shared terminal device installed at a store, the user of a suggestion to dispatch the first vehicle via the shared terminal device.

In the first aspect, the method may further include notifying, when the vehicle dispatch request from the user is acquired via the shared terminal device installed at a store, a computer used by an employee of the store of the boarding position and a planned time at which the first vehicle is to arrive at the boarding position.

In the first aspect, the method may further include notifying, before a second vehicle arrives at a planned position at which the user moving aboard the second vehicle where the shared terminal device is installed exits the second vehicle, the user of a suggestion to dispatch the first vehicle via the shared terminal device.

In the first aspect, the information processing device may determine the hoarding position at which the user boards the first vehicle based on the planned position where the user exits the second vehicle.

In the first aspect, the method may further include notifying the user of the boarding position and a planned time at which the first vehicle is to arrive at the boarding position via a mobile terminal of the user who executes the vehicle dispatch request.

In the first aspect, the vehicle dispatch request may include information indicating a destination when the user moves aboard the first vehicle. The information processing device may determine the traveling plan of the first vehicle such that the first vehicle moves to the destination after the user boards at the boarding position.

An information processing device according to a second aspect of the present disclosure is configured to communicate with a plurality of shared terminal devices respectively installed at places that are different from each other. The information processing device includes a control unit configured to acquire a vehicle dispatch request from a user via each of the shared terminal devices, determine a boarding position at which the user boards a first vehicle, and determine a traveling plan of the first vehicle such that the first vehicle heads toward the boarding position.

In the second aspect, the control unit may notify, when the user starts store leaving procedures using the shared terminal device installed at a store, the user of a suggestion to dispatch the first vehicle via the shared terminal device.

In the second aspect, the control unit may notify, upon acquiring the vehicle dispatch request from the user via the shared terminal device installed at a store, a computer used by an employee of the store of the boarding position and a planned time at which the first vehicle is to arrive at the boarding position.

In the second aspect, the control unit may notify, before a second vehicle arrives at a planned position at which the user moving aboard the second vehicle where the shared terminal device is installed exits the second vehicle, the user of a suggestion to dispatch the first vehicle via the shared terminal device.

In the second aspect, the control unit may determine the boarding position at which the user boards the first vehicle based on the planned position where the user exits the second vehicle.

In the second aspect, the control unit may notify the user of the boarding position and a planned time at which the first vehicle is to arrive at the boarding position via a mobile terminal of the user who executes the vehicle dispatch request.

In the second aspect, the vehicle dispatch request may include information indicating a destination when the user moves aboard the first vehicle. The control unit may determine the traveling plan of the first vehicle such that the first vehicle moves to the destination after the user hoards at the boarding position.

A system according to a third aspect of the present disclosure includes a plurality of shared terminal devices respectively installed at places that are different from each other and an information processing device configured to communicate with the plurality of shared terminal devices. Upon detecting a specific Operation by a user, each of the plurality of shared terminal devices notifies the information processing device of a vehicle dispatch request, and the information processing device acquires the vehicle dispatch request from the user via the shared terminal device, determines a boarding position at which the user boards a first vehicle, and determines a traveling plan of the first vehicle such that the first vehicle heads toward the boarding position.

In the third aspect, the information processing device may notify, when the user starts store leaving procedures using the shared terminal device installed at a store, the shared terminal device of a suggestion to dispatch the first vehicle. The shared terminal device may notify the user of the suggestion to dispatch the first vehicle.

In the third aspect, the information processing device may notify, upon acquiring the vehicle dispatch request from the user via the shared terminal device installed at a store, a computer used by an employee of the store of the boarding position and a planned time at which the first vehicle is to arrive at the boarding position.

In the third aspect, the information processing device may notify, before a second vehicle arrives at a planned position at which the user moving aboard the second vehicle where the shared terminal device is installed exits the second vehicle, the shared terminal device of a suggestion to dispatch the first vehicle. The shared terminal device may notify the user of the suggestion to dispatch the first vehicle.

In the third aspect, the information processing device may determine the boarding position at which the user boards the first vehicle based on the planned position where the user exits the second vehicle.

In the third aspect, the information processing device may notify the user of the boarding position and a planned time at which the first vehicle is to arrive at the boarding position via a mobile terminal of the user who executes the vehicle dispatch request.

With each aspect of the present disclosure, a technology for providing a service using a shared terminal device is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a diagram illustrating a specific example of a shared terminal device;

FIG. 3 is a block diagram illustrating a schematic configuration of the shared terminal device;

FIG. 4 is a block diagram illustrating a schematic configuration of an information processing device;

FIG. 5 is a sequence diagram illustrating a first operation of a system;

FIG. 6 is a sequence diagram illustrating a second operation of the system; and

FIG. 7 is a sequence diagram illustrating a third operation of the system.

### DETAILED DESCRIPTION OF EMBODIMENTS

Hereinafter, embodiments of the present disclosure will be described.

Overview of Embodiments

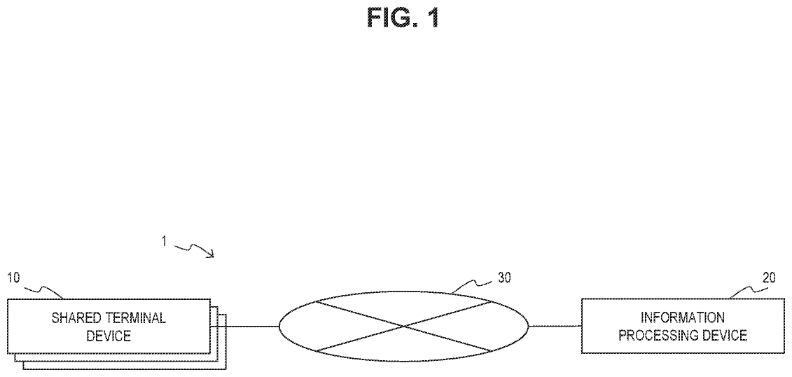

An overview of a system 1 according to an embodiment of the present disclosure will be described with reference to FIG. 1. The system 1 includes a plurality of shared terminal devices 10 and an information processing device 20. Each shared terminal device 10 and the information processing device 20 are communicably connected to a network 30 including, for example, the Internet.

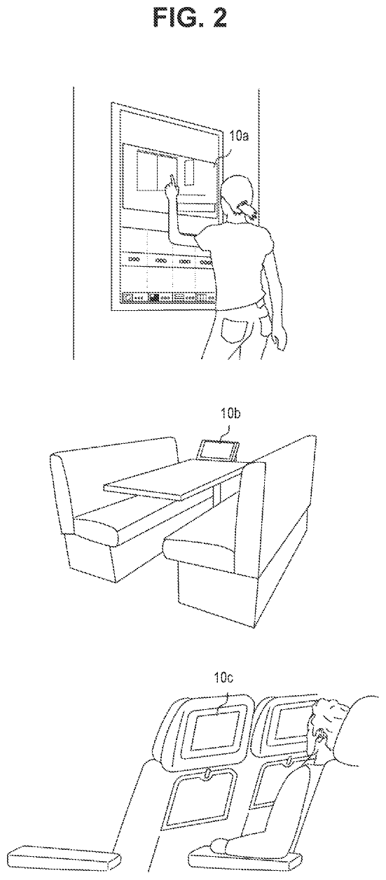

The shared terminal device 10 is any device that can be shared by an unspecified user. For example, a general-purpose electronic device, such as digital signage, a tablet terminal, or a smartphone, or a dedicated electronic device can be employed as the shared terminal device 10. In the present embodiment, the shared terminal devices 10 are respectively installed at places that are different from each other and used for any purposes according to the places where they are installed. For example, FIG. 2 illustrates three shared terminal devices 10a to 10c respectively installed at places that are different from each other. The shared terminal device 10a can be installed at a facility, such as an apartment, a station, or a department store, and used to provide information to the user. The shared terminal device lob can be installed at a store, such as a restaurant, and used to receive an order from a customer. The shared terminal device 10c can be installed at a vehicle, such as a car, a train, or an airplane, and used to provide information to a passenger. Hereinafter, when the shared terminal device 10 is distinguished by a place where it is installed, it is referred to as the shared terminal device 10a, 10b, or 10c, and when it is not distinguished, it is simply referred to as the shared terminal device 10.

The information processing device 20 may be, for example, a server device, but is not limited thereto and may be any computer. The information processing device 20 can communicate with each shared terminal device 10 via the network 30.

First, the overview of the present embodiment will be described and details thereof will be described below. The information processing device 20 can communicate with a plurality of shared terminal devices 10 respectively installed at places that are different from each other. The information processing device 20 acquires a vehicle dispatch request from the user via the shared terminal device 10. The information processing device 20 determines a boarding position at which the user boards, for example, a vehicle (hereinafter, also referred to as a “first vehicle”), such as an on-demand bus or a taxi. Then, the information processing device 20 determines a traveling plan of the first vehicle such that it heads toward the determined boarding position.

As such, according to the present embodiment, even when the user does not have a mobile terminal, such as a smartphone, he/she can request the dispatch of the first vehicle at a place where any shared terminal device 10 is installed. Therefore, the technology for providing services using the shared terminal device is improved in that convenience for the user when requesting the dispatch of the first vehicle is enhanced.

Next, a configuration of each configuration of the system 1 will be described in detail.

Configuration of Shared Terminal Device

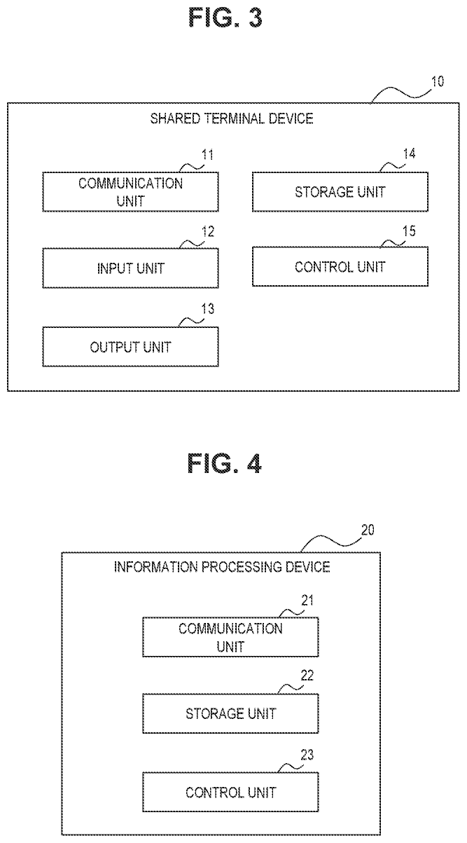

As illustrated in FIG. 3, the shared terminal device 10 includes a communication unit 11, an input unit 12, an output unit 13, a storage unit 14, and a control unit 15.

The communication unit 11 includes one or more communication interfaces connected to the network 30. The communication interface may correspond to, for example, a mobile communication standard, such as Fourth Generation (4G) or Fifth Generation (5G), a wired local area network (LAN) standard, or a wireless LAN standard, but is not limited thereto and may correspond to any communication standard. In the present embodiment, the shared terminal device 10 communicates with the information processing device 20 via the communication unit 11 and the network 30.

The input unit 12 may include one or more input devices that detect user inputs. The input device may be, for example, a physical key, a capacitance key, a touch screen integrally installed with a display, a microphone that receives a voice input, or a camera, but is not limited thereto. The input unit 12 may include an interface used for connecting an external input device thereto.

The output unit 13 may include one or more output devices that output information and notify it to the user. The output device may be, for example, a display that outputs information as video or a speaker that outputs information as audio, but is not limited thereto. The output unit 13 may include an interface used for connecting an external output device thereto.

The storage unit 14 includes one or more memories. The memory may be, for example, a semiconductor memory, a magnetic memory, or an optical memory, but is not limited thereto. Each memory included in the storage unit 14 may function as, for example, a primary storage device, a secondary storage device, or a cache memory. The storage unit 14 stores any information used for an operation of the shared terminal device 10. For example, the storage unit 14 may store a system program, an application program, and embedded software, for example. The information stored in the storage unit 14 may be updatable with information acquired from the network 30 via, for example, the communication unit 11.

The control unit 15 includes one or more processors, one or more programmable circuits, one or more dedicated circuits, or a combination thereof. The processor may be, for example, a general-purpose processor, such as a central processing unit (CPU) or a graphics processing unit (GPU), or a dedicated processor specialized for a specific process, but is not limited thereto. The programmable circuit may be, for example, a field-programmable gate array (FPGA), but is not limited thereto. The dedicated circuit may be, for example, an application specific integrated circuit (ASIC), but is not limited thereto. The control unit 15 controls the entire operation of the shared terminal devices 10,

Configuration of Information Processing Device

As illustrated. in FIG. 4, the information processing device 20 includes a communication unit 21, a storage unit 22, and a control unit 23.

The communication unit 21 includes one or more communication interfaces connected to the network 30. The communication interface may correspond to, for example, a mobile communication standard, a wired LAN standard, or a wireless LAN standard, but is not limited thereto and may correspond to any communication standard. In the present embodiment, the information processing device 20 communicates with each shared terminal device 10 via the communication unit 21 and the network 30.

The storage unit 22 includes one or more memories. Each memory included in the storage unit 22 may function as, for example, a primary storage device, a secondary storage device, or a cache memory. The storage unit 22 stores any information used for an operation of the information processing device 20. For example, the storage unit 22 may store a system program, an application program, a database, and map information. The information stored in the storage unit 22 may be updatable with information acquired from the network 30 via, for example, the communication unit 21.

The control unit 23 includes one or more processors, one or more programmable circuits, one or more dedicated circuits, or a combination thereof. The control unit 23 controls the entire operation of the information processing devices 20.

Operation Flow of System

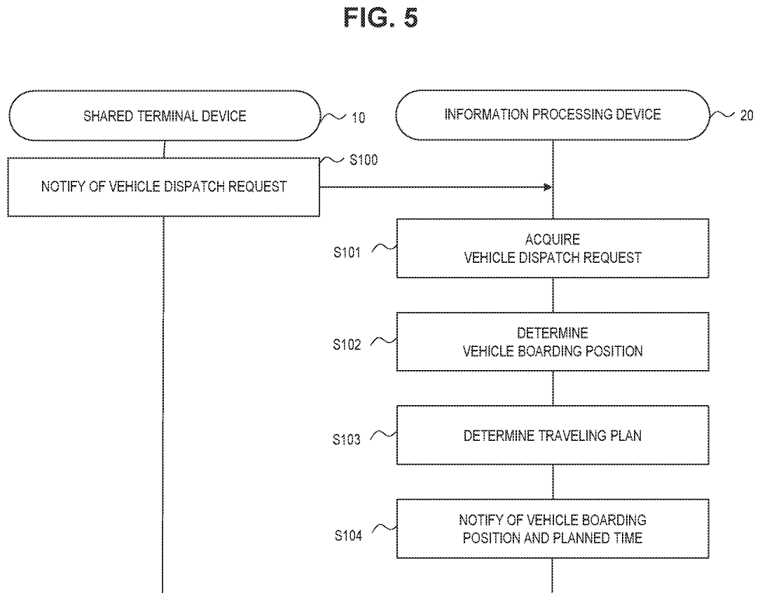

A first operation of the system 1 according to pre present embodiment will be described with reference to FIG. 5.

Step S100: Upon detecting a specific first operation by the user, the control unit 15 of each shared terminal device 10 notifies the information processing device 20 of a vehicle dispatch request, Here, it is assumed that one shared terminal device 10 notifies the information processing device 20 of the vehicle dispatch request.

Specifically, based on a user input to the input unit 12, the control unit 15 detects the fact that the first operation has been executed by the user. The first operation may include, for example, an operation for activating a dedicated application program used for notifying of a vehicle dispatch request and an operation of the user to approve the notification of the vehicle dispatch request, but is not limited thereto and may include any operation. Upon detecting the first operation, the control unit 15 transmits a signal indicating the vehicle dispatch request from the user to the information processing device 20 via the communication unit 11 and the network 30.

The signal indicating the vehicle dispatch request from the user includes, for example, information indicating the place where the shared terminal device 10 is installed. The information indicating the installation place can include, for example, the name or position information of the installation place, but is not limited thereto. The signal indicating the vehicle dispatch request from the user may further include user authentication information. The user authentication information may be, for example, account information including a user and a password, or biometric information including an image, such as a face, fingerprint, vein, or iris, but is not limited thereto. The user authentication information can be acquired using, for example, the camera of the input unit 12.

Step S101: The control unit 23 of the information processing device 20 acquires the vehicle dispatch request from the user via the shared terminal device 10.

Specifically, the control unit 23 receives the signal indicating the vehicle dispatch request from the user from the shared terminal device 10 via the communication unit 21 and the network 30.

Step S102: The control unit 23 determines a boarding position at which the user boards the first vehicle.

Specifically, the control unit 23 specifies the place where the shared terminal device 10 is installed based on, for example, the signal indicating the vehicle dispatch request acquired from the user via the shared terminal device 10. Based on the map information stored in the storage unit 22, the control unit 23 specifies a position at which the first vehicle can stop in order to allow the user to board in the vicinity of the place where the shared terminal device 10 is installed, and determines the specified position as a boarding position. The first vehicle may be, for example, a passenger vehicle, such as an on-demand bus or a taxi, but is not limited thereto and may be any vehicle. When a plurality of stoppable positions is specified, the control unit 23 may automatically select any one of the stoppable positions or enable the user to select a stoppable position via the shared terminal device 10. The control unit 23 determines the selected position as the boarding position.

Step S103: The control unit 23 determines a traveling plan of the first vehicle such that the first vehicle heads toward the boarding position of step S102.

Specifically, the control unit 23 acquires a movement route to the boarding position at which the first vehicle is to arrive, and a planned time where the first vehicle is to arrive at the boarding position. A general route search method can be employed for acquiring the movement route and the planned time. The control unit 23 determines the traveling plan including the acquired movement route and planned time. The traveling plan of the first vehicle includes, for example, information indicating a future movement route of the first vehicle and a position of the first vehicle at each of a plurality of moments, but is not limited thereto and may include any information on the traveling of the first vehicle. The first vehicle travels by autonomous driving, or manual driving by a driver such that the first vehicle heads toward the boarding position according to the traveling plan determined by the information processing device 20.

Step S104: The control unit 23 notifies of the boarding position and the planned time of the first vehicle acquired in step S103.

A notification destination of the boarding position and the planned time may be arbitrarily determined. For example, the notification destination may include the shared terminal device 10. In such a case, the user can recognize the boarding position and the planned time of the first vehicle via the shared terminal device 10. Further, the notification destination may include a mobile terminal of the user. Specifically, the storage unit 14 stores, in advance, information indicating a user account, an e-mail address, or a telephone number used in a mobile terminal of each of a plurality of users. Upon acquiring the user authentication information from the shared terminal device 10 in step S100. the control unit 23 authenticates and specifies the user using the authentication information. The control unit 23 notifies the user's mobile terminal of the boarding position and the planned time of the first vehicle, using the information indicating a user account, an e-mail address, a telephone number, or the like of the specified user. The user can recognize the boarding position and the planned time via the shared terminal device 10 or the mobile terminal.

Further, when the shared terminal device 10 is the shared terminal device 10b installed at a store, the notification destination may include a computer used by an employee of the store. Specifically, the storage unit 14 stores, in advance, information indicating a user account, an e-mail address, a telephone number, or the like used in the computer where the shared terminal device lob is installed. The control unit 23 notifies the computer of the store of the boarding position and the planned time of the first vehicle, using the information. By recognizing the boarding position and the planned time via the computer, the employee of the store can execute a service, such as guiding the user to the boarding position by the planned time.

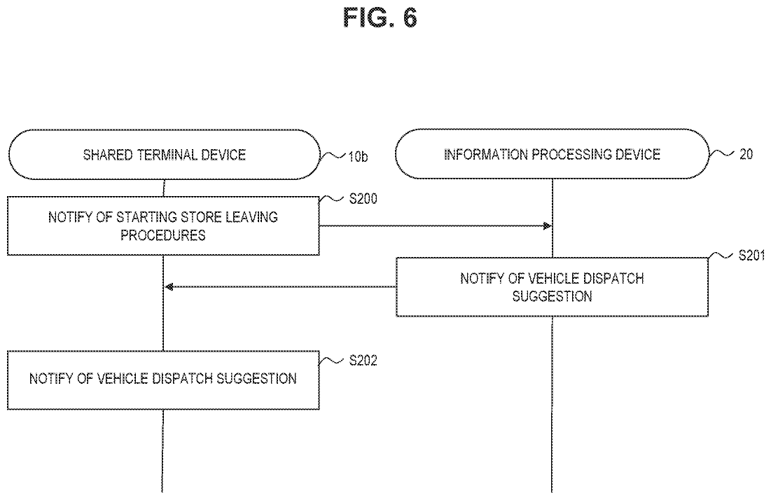

A second operation of the system 1 according to the present embodiment will be described with reference to FIG. 6.

Step S200: Upon detecting a specific second operation by the user, the control unit 15 of the shared terminal device 10b installed at the store starts store leaving procedures. The control unit 15 notifies the information processing device 20 of the start of the store leaving procedures.

Specifically, the control unit 15 transmits a signal indicating the start of the store leaving procedures to the information processing device 20 via the communication unit 11 and the network 30. The second operation can include, for example, an operation for requesting accounting of a fee to be paid by the user at the store, but is not limited thereto and may include any operation. The store leaving procedures can include, for example, payment procedures for a usage fee, but are not limited thereto and may include any procedures executed when the user leaves the store.

Step S201: The control unit 23 of the information processing device 20 notifies the user of a suggestion to dispatch the first vehicle (hereinafter, also referred to as a “vehicle dispatch suggestion”) via the shared terminal device 10b.

Specifically, the control unit 23 transmits information indicating the vehicle dispatch suggestion to the shared terminal device lob via the communication unit 21 and the network 30. The information indicating the vehicle dispatch suggestion includes, for example, a message suggesting to dispatch the first vehicle to the user, but is not limited thereto.

Step S202: The control unit 15 of the shared terminal device 10b notifies the user of the vehicle dispatch suggestion acquired from the information processing device 20.

Specifically, the control unit 15 notifies the user of the information indicating the vehicle dispatch suggestion via the output unit 13. By the notification of the vehicle dispatch suggestion, the user can recognize that the dispatch of the first vehicle can be requested via the shared terminal device 10b.

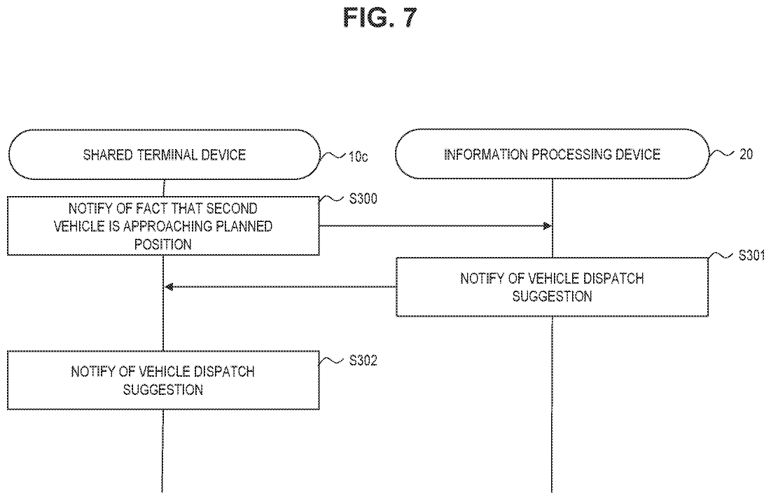

A third operation of the system 1 according to the present embodiment will be described with reference to FIG. 7.

Step S300: Before the second vehicle arrives at a planned position at which the user moving aboard the second vehicle exits it, the control unit 15 of the shared terminal device 10c installed at a second vehicle notifies the information processing device 20 of the fact that the second vehicle is approaching the planned position,

The second vehicle may be, for example, a vehicle, such as an automobile, a train, or an airplane, but is not limited thereto and may be any passenger vehicle. Using any method, the control unit 15 can detect the fact that the second vehicle is approaching the planned position. For example, when a distance between a current position and the planned position of the second vehicle is lower than a predetermined threshold value, the control unit 15 may determine that the second vehicle is approaching the planned position.

Step S301: The control unit 23 of the information processing device 20 notifies the user of the vehicle dispatch suggestion via the shared terminal device 10c.

Step S302: The control unit 15 of the shared terminal device 10c notifies the user of the vehicle dispatch suggestion acquired from the information processing device 20.

As described above, the information processing device 20 according to the present embodiment can communicate with the shared terminal devices 10 respectively installed at places that are different from each other. The information processing device 20 acquires the vehicle dispatch request from the user via the shared terminal device 10. The information processing device 20 determines the boarding position at which the user boards the first vehicle. Then, the information processing device 20 determines a traveling plan of the first vehicle such that the first vehicle heads toward the determined boarding position.

With such a configuration, even when the user does not have a mobile terminal, such as a smartphone, he/she can request dispatch of the first vehicle to the place where any shared terminal device 10 is installed. Therefore, the technology for providing services using the shared terminal device is improved in that convenience for the user when requesting the dispatch of the first vehicle is enhanced.

The present disclosure has been described above with reference to the drawings and the embodiments. However, it should be noted that a person skilled in the art can make variations and modifications thereto, based on the present disclosure. Therefore, it should be noted that these variations and modifications fall within the scope of the present disclosure. For example, functions, and the like, included in each element, each step, or the like, can be rearranged so as not to be logically contradictory, and a plurality of elements, steps, or the like, may be combined into one or divided.

For example, in the above-described embodiment, it is possible to distribute the configuration and the operation of the information processing device 20 to a plurality of computers capable of communicating with each other.

Further, it is also possible to cause, for example, a general-purpose computer to function as the shared terminal device 10 or the information processing device 20 according to the above-described embodiment. Specifically, a program describing processing contents for implementing each function of the shared terminal device 10 or the information processing device 20 according to the above-described embodiment is stored in a memory of the general-purpose computer, and the program is read and executed by the processor. Therefore, it is also possible to implement the disclosure according to the present embodiment as a program that can be executed by a processor or a non-transitory computer-readable medium storing the program.

What is claimed is:

1. A method executed by an information processing device configured to communicate with a plurality of shared terminal devices respectively installed at places that are different from each other, the method comprising:
acquiring a vehicle dispatch request from a user via each of the shared terminal devices;
determining a boarding position at which the user boards a first vehicle; and
determining a traveling plan of the first vehicle such that the first vehicle heads toward the boarding position.

2. The method according to claim 1, further comprising:
notifying, when the user starts store leaving procedures using the shared terminal device installed at a store, the user of a suggestion to dispatch the first vehicle via the shared terminal device.

3. The method according to claim 1, further comprising:
notifying, when the vehicle dispatch request from the user is acquired via the shared terminal device installed at a store, a computer used by an employee of the store of the boarding position and a planned time at which the first vehicle is to arrive at the boarding position.

4. The method according to claim 1, further comprising:
notifying, before a second vehicle arrives at a planned position at which the user moving aboard the second vehicle where the shared terminal device is installed exits the second vehicle, the user of a suggestion to dispatch the first vehicle via the shared terminal device.

5. The method according to claim 4. wherein the information processing device is configured to determine the boarding position at which the user boards the first vehicle based on the planned position where the user exits the second vehicle.

6. The method according to claim 1, further comprising:
notifying the user of the boarding position and a planned time at which the first vehicle is to arrive at the boarding position via a mobile terminal of the user who executes the vehicle dispatch request.

7. The method according to claim 1, wherein:
the vehicle dispatch request includes information indicating a destination when the user moves aboard the first vehicle; and
the information processing device is configured to determine the traveling plan of the first vehicle such that the first vehicle moves to the destination after the user boards at the boarding position.

8. An information processing device configured to communicate with a plurality of shared terminal devices respectively installed at places that are different from each other, the information processing device comprising a control unit configured to:
acquire a vehicle dispatch request from a user via each of the shared terminal devices;
determine a boarding position at which the user boards a first vehicle; and
determine a traveling plan of the first vehicle such that the first vehicle heads toward the boarding position.

9. The information processing device according to claim 8, wherein the control unit is configured to, when the user starts store leaving procedures using the shared terminal device installed at a store, notify the user of a suggestion to dispatch the first vehicle via the shared terminal device.

10. The information processing device according to claim 8, wherein the control unit is configured to, upon acquiring the vehicle dispatch request from the user via the shared terminal device installed at a store, notify a computer used by an employee of the store of the boarding position and a planned time at which the first vehicle is to arrive at the boarding position.

11. The information processing device according to claim 8, wherein the control unit is configured to, before a second vehicle arrives at a planned position at which the user moving aboard the second vehicle where the shared terminal device is installed exits the second vehicle, notify the user of a suggestion to dispatch the first vehicle via the shared terminal device.

12. The information processing device according to claim 11, wherein the control unit is configured to determine the boarding position at which the user boards the first vehicle based on the planned position where the user exits the second vehicle.

13. The information processing device according to claim 8, wherein the control unit is configured to notify the user of the boarding position and a planned time at which the first vehicle is to arrive at the boarding position via a mobile terminal of the user who executes the vehicle dispatch request.

14. The information processing device according to claim 8, wherein:
the vehicle dispatch request includes information indicating a destination when the user moves aboard the first vehicle; and
the control unit is configured to determine the traveling plan of the first vehicle such that the first vehicle moves to the destination after the user boards at the boarding position.

15. A system comprising:
a plurality of shared terminal devices respectively installed at places that are different from each other; and
an information processing device configured to communicate with the plurality of shared terminal devices, wherein:
each of the plurality of shared terminal devices is configured to, upon detecting a specific operation by a user, notify the information processing device of a vehicle dispatch request; and
the information processing device is configured to acquire the vehicle dispatch request from the user via the shared terminal device, determine a boarding position at which the user boards a first vehicle, and determine a traveling plan of the first vehicle such that the first vehicle heads toward the boarding position.

16. The system according to claim 15, wherein:
the information processing device is configured to, when the user starts store leaving procedures using the shared terminal device installed at a store, notify the shared terminal device of a suggestion to dispatch the first vehicle; and
the shared terminal device is configured to notify the user of the suggestion to dispatch the first vehicle.

17. The system according to claim 15, wherein the information processing device is configured to, upon acquiring the vehicle dispatch request from the user via the shared terminal device installed at a store, notify a computer used by an employee of the store of the hoarding position and a planned time at which the first vehicle is to arrive at the hoarding position.

18. The system according to claim 15, wherein:
the information processing device is configured to, before a second vehicle arrives at a planned position at which the user moving aboard the second vehicle where the shared terminal device is installed exits the second vehicle, notify the shared terminal device of a suggestion to dispatch the first vehicle; and
the shared terminal device is configured to notify the user of the suggestion to dispatch the first vehicle.

19. The system according to claim 18, wherein the information processing device is configured to determine the boarding position at which the user boards the first vehicle based on the planned position where the user exits the second vehicle.

20. The system according to claim 15, wherein the information processing device is configured to notify the user of the boarding position and a planned time at which the first vehicle is to arrive at the boarding position via a mobile terminal of the user who executes the vehicle dispatch request.
